(19) United States
(12) Patent Application Publication
(10) Pub. No.: US 2006/0121926 A1
(43) Pub. Date: Jun. 8, 2006

(54) Method for displaying image of talker during PTT call service in mobile communication terminal

(75) Inventor: Ou-Jin Joung, Anyang-si (JP)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/297,728

(22) Filed: Dec. 8, 2005

(30) Foreign Application Priority Data
Dec. 8, 2004 (KR) 2004-0102934

(51) Int. Cl. H04B 7/00

(52) U.S. Cl. 455/518

(57) ABSTRACT

Disclosed is a method for displaying an image of a talker during a PTT call service in a mobile communication terminal. In the method, a current state is checked during a PTT call service. When the current state is a listening state, an image of a talker is read from a contact list and the read image is displayed on a screen. When the current state is a speaking state, a list of participants is displayed, in which a user name of the mobile communication terminal is highlighted. When the current state is a waiting state, a list of the participants is displayed on the screen, in which a waiting state icon is inserted at a position where a user name of the mobile communication terminal is displayed. Accordingly, the talker can be recognized more clearly during the PTT call service (or a POC call service).

### PRIORITY

This application claims priority under 35 U.S.C. § 119 to an application entitled “Method For Displaying Talker During Call Service In Mobile Communication Terminal” filed in the Korean Intellectual Property Office on Dec. 8, 2004 and assigned Serial No. 2004-102934, the contents of which are incorporated herein by reference.

### BACKGROUND OF THE INVENTION

1. Field of the Invention

The present invention relates to a PTT call service method of a mobile communication terminal, and more particularly, to a method for displaying an image of a talker during a PTT call service.

2. Discussion of the Related Art

Mobile communication systems can be classified into audio service systems and data service systems according to their utilization. A representative example of a mobile communication system is a Code Division Multiple Access (CDMA) system. In the CDMA system, an International Standard (IS-95) system supports only an audio service. With recent developments in communication technology, mobile communication systems have made progress toward a high-speed data service. For example, a CDMA2000 1x system supports both an audio service and a high-speed data service. Mobile communication systems are also developing toward a multimedia service and a Push To Talk (PTT) service, as well as a regular one-to-one voice communication.

In using the PTT service, a user logs in and selects a group or a member who he or she wants to communicate with among groups of co-workers or friends or others displayed on a terminal. Then, the user requests and initiates a PTT call service. After a one-to-one or intergroup communication path is set on a network that can provide the PTT service, the call can be in service through the set communication path. Specifically, unlike a general phone, the PTT service can directly provide a call service by pressing a PTT button. Also, a group call with more than three participants is possible, thus obtaining the economic advantage.

A PTT service using a Session Initiation Protocol (SIP) in the mobile communication system is called a Push to Talk over Cellular (POC). Hereinafter, the POC service and the PTT service will be used interchangeably.

FIG. 1 is a block diagram of a network configuration that provides a POC service in a mobile communication system.

The network configuration includes a User Agent (UA) 10 for supporting a POC service and providing a wireless access based on a CDMA2000 1x standard, a CDMA2000 1x Access Network (AN) 20 for transmitting/receiving packets to/from the UA 10 over a wireless channel, a Packet Data Service Node (PDSN) 30 for connecting the AN 20 with an Internet Protocol (IP) network 40 using an IP, and a POC server 50 connected to the IP network 40 to manage a POC session and relay a packet from a person talking (hereinafter a talker) to a plurality of listeners.

In such a POC service network, an SIP may be used as a POC service protocol for a signaling transmission. A Real-time Transport Protocol (RTP) may be used for real-time packet transmission. The SIP is an end-to-end and server-client signaling protocol, and exchanges necessary session information before a call starts, and removes session information after the call ends.

Compared with a traditional PTT service (for example, a Trunked Radio System (TRS)), the POC service has an advantage in that participants of a current group call can be checked and a phone number or nickname of a talker having a right to speak can be checked visually.

However, the POC service is much inferior to the traditional PTT service (for example, the TRS) in view of basic functions (for example, call connection rate, members in a duplex system, voice transmission delay). The POC service is planning to provide a Push-To-Video service, in addition to the PTT service. If the PTT service is rapidly commercialized, the users can make use of the POC service more conveniently. However, because the time of the commercialization is ambiguous, other approaches are demanded.

As shown in FIG. 2, when a group call starts, phone numbers (or names) of the participants are displayed on a screen and a phone number of a talker having a right to speak is highlighted. Since the POC service uses a general data call, it provides a low quality of sound compared with a voice call. Therefore, it difficult to identify who speaks. As such, there is a demand for a method of displaying an image of a talker having a right to speak, instead of simply displaying texts (phone number or nickname).

### SUMMARY OF THE INVENTION

The present invention provides a method for displaying an image of a talker during a PTT call service in a mobile communication terminal.

Also, the present invention provides a method for registering images of participants in a contact list for a PTT call service in a mobile communication terminal.

According to an aspect of the present invention, there is provided a method for displaying an image of a talker during a PTT call service in a mobile communication terminal, the method including checking whether a current state is a listening state during a PTT call service; and when the current state is the listening state, reading an image of a talker from a contact list and displaying the read image on a screen.

According to another aspect of the present invention, there is provided a method for displaying an image of a talker during a PTT call service in a mobile communication terminal, the method including reading an image of a talker from a contact list during a PTT call mode; and displaying the read image of the talker on a screen.

According to a further another aspect of the present invention, there is provided a method for displaying an image of a talker during a PTT call service in a mobile communication terminal, the method including checking a current state during a PTT call service; when the current state is a listening state, reading an image of a talker from a contact list and displaying the read image on a screen; when the current state is a speaking state, displaying a list of participants, wherein a user name of the mobile communication terminal is highlighted; and when the current state is a waiting state, displaying a list of the participants on the screen, wherein a waiting state icon is inserted at a position where a user name of the mobile communication terminal is displayed.

According to a still further another aspect of the present invention, there is provided a method for registering images of participants in a contact list for a PTT call in a mobile communication terminal, the method including checking an input of a key for storing an image in the contact list in a state that a content of a received multimedia message is displayed; when the key is input, extracting an image from the received multimedia message; and storing the extracted image in the contact list.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a network configuration for providing a POC service in a mobile communication system;

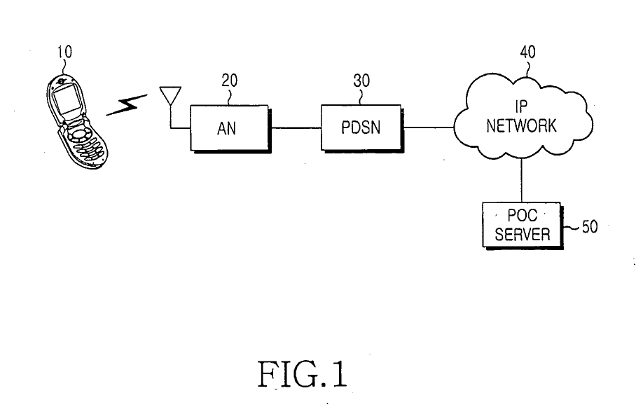

FIG. 2 is a diagram illustrating exemplary displays on a screen of a talker's mobile communication terminal during a PTT call service according to the prior art.

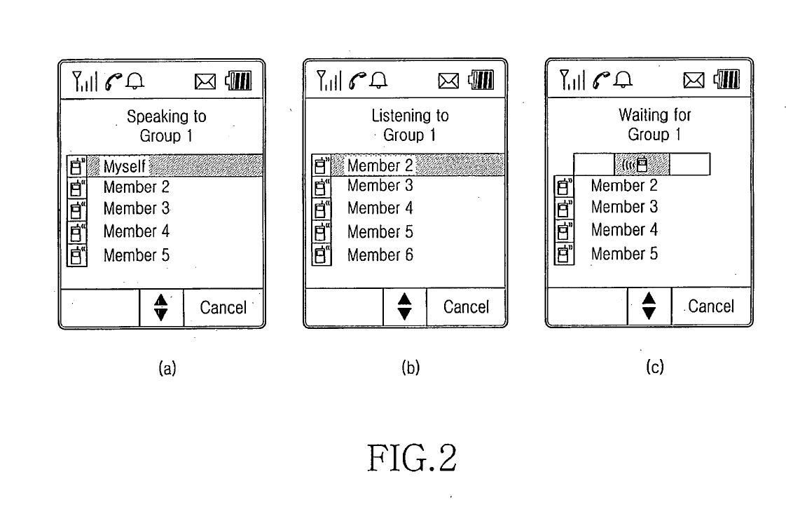

FIG. 3 is a block diagram of a mobile communication terminal according to an embodiment of the present invention;

FIG. 4 is a flowchart illustrating a method for registering an image in a POC contact list in a mobile communication terminal according to an embodiment of the present invention;

FIG. 5 is a flowchart illustrating a method for providing a POC call service using a POC contact list containing registered images in a mobile communication terminal according to an embodiment of the present invention; and

FIG. 6 is a diagram illustrating exemplary displays on a screen of a talker's mobile communication terminal during a PTT call service according to the present invention.

### DETAILED DESCRIPTION OF THE PREFERRED EMBODIMENTS

Reference will now be made in detail to the preferred embodiments of the present invention, examples of which are illustrated in the accompanying drawings. A detail description of well-known features will be omitted for conciseness.

Hereinafter, a method for displaying images (photographs, avatars, etc.) of participants during a PTT call service in a mobile communication terminal will be described in detail. Specifically, a method for displaying an image of a talker having a right to speak will be described. During the PTT call service, phone numbers of the talker or other participants can be checked in real time. A POC contact list is retrieved using the phone number of the talker having the right to speak, and an image of the talker registered in the POC contact list is displayed on a screen.

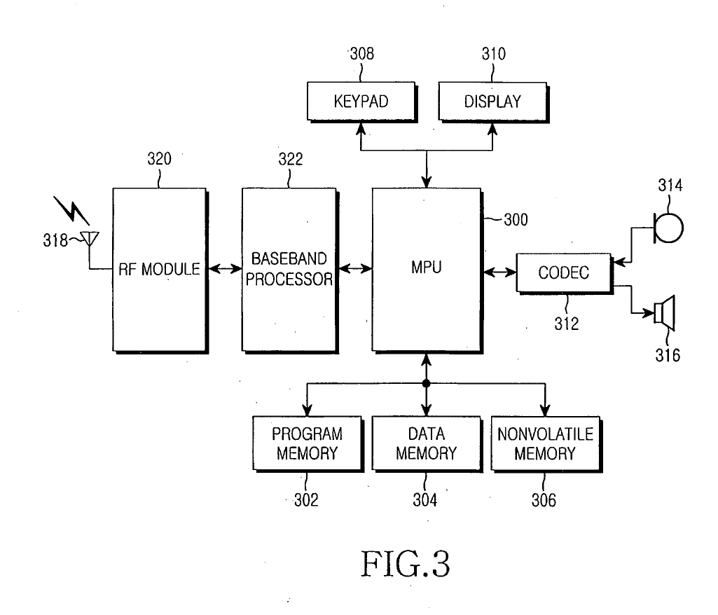

FIG. 3 is a block diagram of a mobile communication terminal according to an embodiment of the present invention. It is assumed that the mobile communication terminal is a terminal that Supports a PTT service and provides a wireless access based on a CDMA2000 1x standard.

Referring to FIG. 3, a microprocessor unit (MPU) 300 controls an overall operation of the mobile communication terminal. For example, the MPU 300 processes and controls voice communication and data communication. In addition to the typical functions, the MPU 300 supports a PTT service and processes a function of displaying an image of a talker having a right to speak during a PTT call service. A description about the typical process and control operations of the MPU 300 will be omitted.

A program memory 302, a data memory 304 and a nonvolatile memory 306 are included. Although shown separately, these memories obviously can be a single unit. The program memory 302 stores a program for controlling an overall operation of the mobile communication terminal. A flash memory may be used for the program memory 302. The data memory 304 temporarily stores data that is created during the operation of the mobile communication terminal. A Random Access Memory (RAM) may be used for the data memory 304. The nonvolatile memory 306 stores system parameters and other data (e.g., phone number and SMS message). An Electrically Erasable and Programmable Read Only Memory (EEPROM) may be used for the nonvolatile memory 306. In this embodiment, the memory stores a POC contact list that is a list of PTT call partners registered by a user. Preferably, the POC contact list includes phone numbers, nicknames and images of the call partners.

A keypad 308 includes numeric keys of digits 0-9 and a plurality of function keys, such as a Menu key, a Cancel (Delete) key, a Conformation key, a Talk key, an End key, an Internet connection key, and Navigation keys (Left/Right/Up/Down). A key input data corresponding to a key pressed by the user is transferred to the MPU 300. Also, a side key for the PTT call service preferably is provided on a main body of the mobile terminal, for example on the left side of the terminal. A display 310 displays status information (or indicator) of the mobile communication terminal, numerals and characters, moving pictures and still pictures, and the like. A color Liquid Crystal Display (LCD) may be used for the display 310.

A coder-decoder (CODEC) 312 connected to the MPU 300, a speaker 316 and a microphone 314 connected to the CODEC 312 are an audio input/output block that is used for a phone call. The MPU 300 produces pulse code modulated (PCM) data and the CODEC 312 converts the PCM data into analog audio signals. The analog audio signals are output through the speaker 316. Also, the CODEC 312 converts audio signals received through the microphone 314 into PCM data and provides the PCM data to the MPU 300.

A Radio Frequency (RF) module 320 down-converts RF signals received through an antenna 318 and provides the down-converted signal to a baseband processor 322. Also, the RF module 320 up-converts a baseband signal provided from the baseband processor 322 and transmits the up-converted baseband signal through the antenna 318. The baseband processor 322 processes the baseband signals that are transmitted/received between the RF module 320 and the MPU 300. For example, in the case of the data transmission, the baseband processor 322 performs channel coding and spreading on the transmit data according to a corresponding radio access standard (e.g., CDMA2000 1x). In the case of the data reception, the baseband processor 322 performs despreading and channel decoding on the received data.

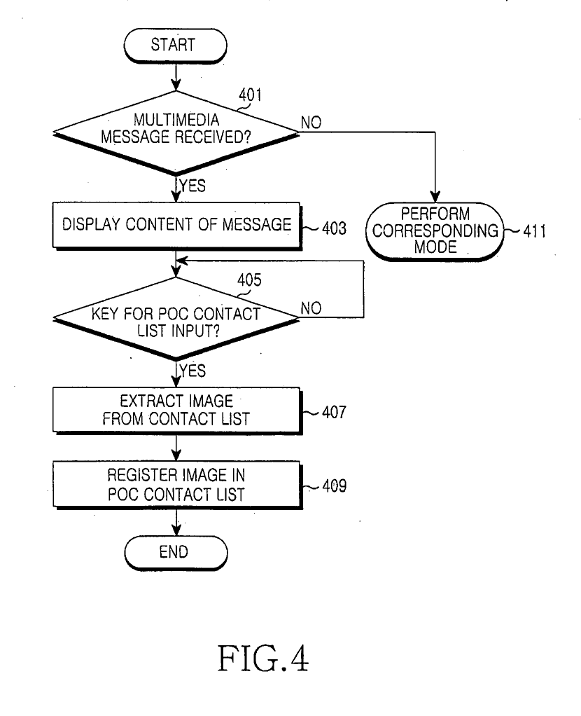

FIG. 4 is a flowchart illustrating a method for registering an image in a POC contact list in a mobile communication terminal according to an embodiment of the present invention. Specifically, a method for automatically registering an image received through a multimedia message in a POC contact list is illustrated in FIG. 4. The multimedia message includes all messages that can transmit an image. For example, the multimedia message can be a Multimedia Messaging Service (MMS) message, an E-mail message, or an Enhanced Messaging Service (EMS) message. Alternatively, a receiver can download an image on a wireless web using the link information that is transmitted to the receiver through an SMS message. This type of the service is supported by the present system.

Referring to FIG. 4, in step 401, the MPU 300 checks whether a multimedia message is received. In step 411, when the multimedia message is not received, the MPU 300 performs a corresponding mode. In step 403, when the multimedia message is received, the MPU 300 displays the contents of the received multimedia message on a display. At this point, the MPU 300 retrieves a phone book using a phone number of a calling party, which is contained in a header of the message, and acquires the name of the calling party, and then displays both the phone number of the calling party and the name of the calling party on a screen.

In step 405, when the contents of the multimedia message are displayed, the MPU 300 checks whether a key for storing an image in a POC contact list is input through a user's manipulation. In step 407, when the key is input, the MPU 300 extracts an image from the multimedia message.

In step 409, after extracting the image, the MPU 300 registers the extracted image in the POC contact list. If the calling party who transmits the message is not registered in the POC contact list, calling party information including the extracted image can be automatically registered in the POC contact list.

In this embodiment, although the image received through the multimedia message is registered in the POC contact list, an image stored in a phone book or photo album can also be registered in the POC contact list.

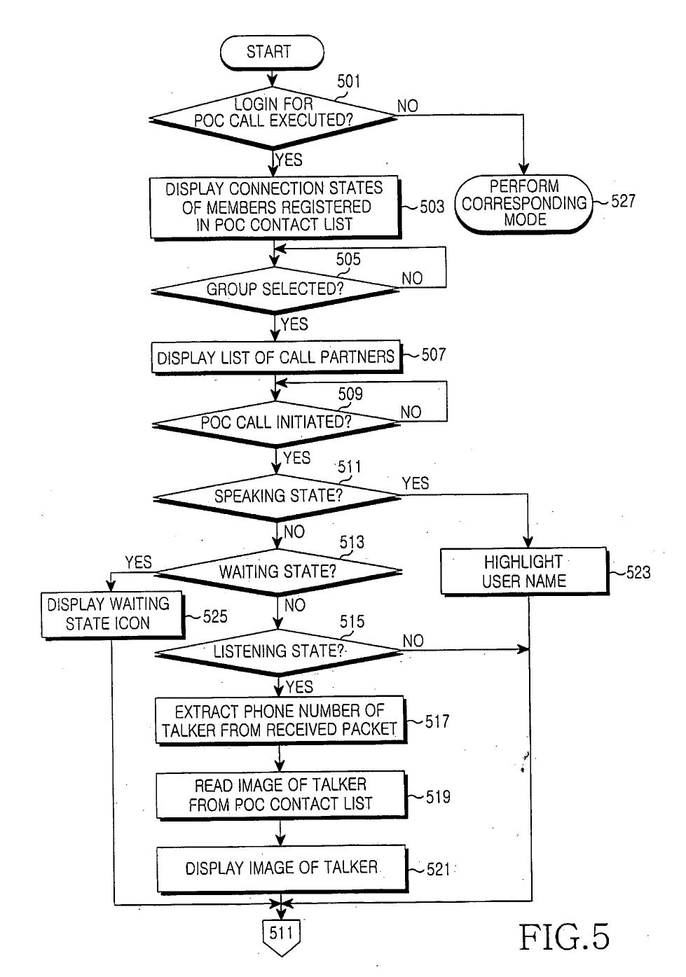

FIG. 5 is a flowchart illustrating the POC call method using the POC contact list where the images are registered in the mobile communication terminal according to an embodiment of the present invention.

Referring to FIG. 5, in step 501, the MPU 300 checks whether a login for a POC call is executed. In step 527, when the login for the POC call is not executed, the MPU 300 performs a corresponding mode (e.g., a waiting mode).

In step 503, when the login for the POC call is executed, the MPU 300 receives connection states (login state or logout state) of members, who are registered in the POC contact list, from a network (or a POC server) and displays it.

In step 505, after displaying the connection states, the MPU 300 checks whether a call partner is selected by the user. The user can select a group for a group call or one partner for a one-to-one call. Hereinafter, it is assumed that the group call is selected. In step 507, when the call partner is selected, the MPU 300 displays the selected call partners (members of the selected group). In step 509, the MPU 300 checks whether the POC call is initiated. The POC call initiation can be detected by a user's press of the POC button. Once the POC call is initiated, the mobile communication terminal operates in a speaking state, a listening state, or a waiting state.

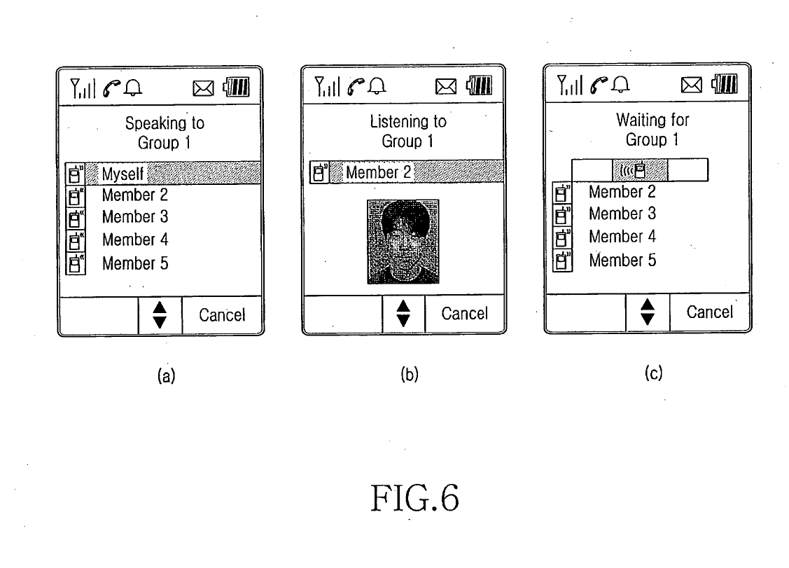

In step 511, the MPU 300 checks whether a current state is the speaking state. In step 523, when the current state is the speaking state, the MPU 300 displays a list of call participants on a screen. In the list of the call participants, a user name (for example, “Myself”) is highlighted as shown in FIG. 6(a). Then, the process returns to step 511. Also, the image of the user can be displayed.

In step 513, when the current state is not the speaking state, the MPU 300 checks whether the current state is the waiting state. In step 525, when the current state is the waiting state, the MPU 300 displays a list of call participants, where a waiting-state ion is inserted at a user name position as shown in FIG. 6(c). Then, the process returns to step 511.

In step 515, when the current state is not the waiting state, the MPU 300 checks whether the current state is the listening state. In step 517, when the current state is the listening state, the MPU 300 extracts a phone number of a calling party (or a phone number of a talker) from an incoming voice packet. In step 519, the MPU 300 retrieves the POC contact list stored in the memory by using the extracted phone number of the calling party, and then reads the image of the calling party. In step 521, the MPU 300 displays the read image of the calling party as shown in FIG. 6(b), and then the process returns to step 511.

As described above, during the PTT call mode, a phone number of a talker having a right to speak can be extracted in real time and the POC contact list is retrieved using the extracted phone number, and the image of the talker can be displayed. The image of the talker can be set in a POC setting menu.

According to the present invention, since the image of the talker is displayed on the screen during the POC call service (or the PTT call service), a talker can be recognized more clearly. Specifically, it is possible to solve the problem in which the talker's voice cannot be correctly recognized due to degradation of the sound quality. Even in the case of the Push-To-Video service expected to be commercialized in the future, where the server must be upgraded, the present POC server can be used as it is, and a similar effect can be obtained by the change of functions in the mobile communication terminal.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for displaying an image of a talker during a PTT (Push To Talk) call service in a mobile communication terminal, the method comprising the steps of:
checking whether a current state is a listening state during a PTT call service; and
when the current state is the listening state, reading an image of a talker from a contact list and displaying the read image on a screen.

2. The method of claim 1, wherein the contact list stores names, phone numbers, and images of participants.

3. The method of claim 1, further comprising the step of:
when the current state is a speaking state, displaying a list of participants on the screen, and highlighting the name of a user of the mobile communication terminal.

4. The method of claim 1, further comprising the step of:
when the current state is a waiting state, displaying a list of participants on the screen, and inserting a waiting state icon at a position where the name of a user of the mobile communication terminal is displayed.

5. The method of claim 1, wherein the step of displaying the image read from the contact list includes:
extracting a phone number of the talker from an incoming voice packet when the current state is the listening state;
retrieving the contact list using the extracted phone number of the talker, and reading the image of the talker; and
displaying the read image of the talker on the screen.

6. A method for displaying an image of a talker during a PTT (Push To Talk) call service in a mobile communication terminal, the method comprising the steps of:
reading an image of a talker from a contact list during a PTT call mode; and
displaying the read image of the talker on a screen.

7. The method of claim 6, wherein the contact list stores names, phone numbers, and images of participants.

8. The method of claim 6, further comprising the step of:
when the talker is a user of the mobile communication terminal, displaying a list of the participants on the screen, and highlighting the name of the user.

9. The method of claim 6, further comprising the step of:
when the talker is not detected, displaying a list of the participants on the screen, and inserting a waiting state icon at a position where the name of a user of the mobile communication terminal is displayed.

10. A method for displaying an image of a talker during a PTT (Push To Talk) call service in a mobile communication terminal, the method comprising the steps of:
checking a current state during a PTT call service;
when the current state is a listening state, reading an image of a talker from a contact list and displaying the read image on a screen;
when the current state is a speaking state, displaying a list of participants, and highlighting the name of a user of the mobile communication terminal is; and
when the current state is a waiting state, displaying a list of the participants on the screen, and inserting a waiting state icon at a position where the name of a user of the mobile communication terminal is displayed.

11. The method of claim 10, wherein the contact list stores names, phone numbers, and images of the participants.

12. A method for registering images of participants in a contact list for a PTT (Push To Talk) call in a mobile communication terminal, the method comprising the steps of:
checking an input of a key for storing an image in the contact list in a state that a content of a received multimedia message is displayed;
when the key is input, extracting an image from the received multimedia message; and
storing the extracted image in the contact list.

13. A method for displaying an image of a talker during a PTT (Push To Talk) call service in a mobile communication terminal, the method comprising the steps of:
checking a state during a PTT call service;
reading an image of a talker from a list if the state is a listening state; and
displaying the read image of a talker on a screen.

14. The method of claim 13, wherein the list stores names, phone numbers, and images of participants.

15. The method of claim 13, further comprising the step of:
displaying a list of participants on the screen, and highlighting the name of a user of the mobile communication terminal if the state is a speaking state.

16. The method of claim 13, further comprising the step of:
displaying a list of participants on the screen, and inserting a waiting state icon at a position where the name a user of the mobile communication terminal is displayed if the state is a waiting state.

17. A method for displaying an image of a talker during a call service in a mobile communication terminal, the method comprising the steps of:
checking a current state during a call service;
when the current state is a listening state, reading an image of a talker and displaying the read image on a screen; and
when the current state is a waiting state, displaying a waiting state icon inserted at a position where the name of a user of the mobile communication terminal is displayed.
